(19) United States
(12) Patent Application Publication
(10) Pub. No.: US 2007/0183288 A1
(43) Pub. Date: Aug. 9, 2007

(54) Method and device for recording marks in an information layer of an optical record carrier

(75) Inventors: Erwin Rinaldo Meinders, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,569

(22) PCT Filed: Mar. 3, 2005
(86) PCT No.: PCT/IB05/50781

§ 371 Date: Sep. 5, 2006

(30) Foreign Application Priority Data
Mar. 10, 2004 (EP) 04100971.3

(51) Int. Cl. G11B 7/0045

(52) U.S. Cl. 369/59.11; 369/59.12

(57) ABSTRACT

The present invention relates to a method and a corresponding device for recording marks representing data in an information layer of a record carrier by irradiating the information layer by means of a pulsed radiation beam, wherein a mark is written by a sequence of write pulses, the number of write pulses of the sequence for writing a mark of length NT, T being the length of a reference clock, being determined by application of a predetermined write strategy. In order to make use of new lasers and laser drivers generating shorter laser pulses and in order to enable precise mark edge positioning leading to less bit errors it is proposed that for writing a mark of length NT either a first write strategy using (N+k) write pulses, a second write strategy using trunk(N/2+k) write pulses, or a third write strategy using trunk(N/3+k) write pulses, k being an integer equal to or larger than one, is applied.

The present invention relates to a method of recording marks representing data in an information layer of a record carrier by irradiating the information layer by means of a pulsed radiation beam, wherein a mark is written by a sequence of write pulses, the number of write pulses of the sequence for writing a mark of length NT, T being the length of a reference clock, being determined by application of a predetermined write strategy.

The present invention further relates to a corresponding recording device comprising a radiation source and a control unit.

In optical data storage systems data is stored on optical record carriers, such as optical discs. The data is placed along data tracks which typically form a spiral on the disc substrate. Optical data storage media can be divided in three classes: read-only (ROM), recordable or write-once (R or WO), and rewritable (RW or RE). In the case of recordable, write-once, and rewritable media the disc has an active layer (also called information layer) which is often a part of a recording stack. One of the features of this active layer is that its optical properties can be changed by means of heating with a laser beam. In this way, the material of the active layer can be converted from one state to another state in a reversible (rewritable optical media) or irreversible (write-once optical media) way.

Data recording is done in the active layer by creating a sequence of marks. The optical properties of these marks are different from those of the surrounding matrix. Separations between the marks along the data track are called spaces. The information is encoded in the length of the marks and of the spaces. The optical contrast between the states allows detecting the mark-to-space transitions. In this way the length of an individual mark or space in the sequence can be determined, and stored information can be retrieved.

The unity of mark/space length is called the channel bit length and is often denoted as 1T. In each type of optical storage systems a certain set of mark/space lengths is employed. This set is typically a sequence of succeeding integers in the NₘᵢₙT to NₘₐₓT range. For example, in DVD (Digital Versatile Disc) Nₘᵢₙ=3 and Nₘₐₓ=11, and the set of 3T to 11T lengths is used. In the case of BD (Blu-ray Disc) Nₘᵢₙ=2 and Nₘₐₓ=8. and the set of 2T to 8T lengths is used. For the system performance it is vital that each mark and space in the data sequence has the correct length.

As has been mentioned above, data recording in an optical system is a thermal process. To achieve the correct lengths of the marks and spaces certain write strategies are applied that match the thermal response of the recording media. In particular, pulsed write strategies are often used for rewritable media. For example, in the case of rewritable media Sb-based phase-change material is used as active layer. Recording is realized by heating the crystalline phase-change layer locally above its melting point, thus melting the material, using a focused laser beam, and subsequently letting the material cool down with a certain cooling rate. When sufficient cooling rate is provided amorphous marks are left in the crystalline background of the active layer. However, when (long) marks are written with a continuous laser pulse too much heat is accumulated in the phase change layer. This leads already during the recording process to a complete recrystallization (that is, erasure) of the mark being written.

To overcome this problem, instead of a continuous write pulse a sequence of short write pulses (that is, a pulse train) is used. In such a pulse train the write pulses are separated by gaps. As a result i) less total energy is pumped into the active layer since the integrated time when the write pulse is “ON” is shorter than in the case of a continuous pulse, and ii) a higher cooling rate is achieved due to the presence of the gaps between the write pulses. In such a write strategy each pulse-gap pair results in a small amorphous dot.

To achieve a desired mark length a certain number of write pulses in the pulse train has to be applied. At present the following write strategies are known:
1T (N−1, respectively N−2) write strategy: in this write strategy the number of pulses in the pulse train is N−1, respectively N−2, where N is the length of the mark in channel bits. Using this write strategy a 3T long mark is written with 2, respectively 1, write pulses, a 4T long mark is written with 3, respectively 2, write pulses, etc.
2T (or N/2) write strategy: in this write strategy the number of pulses in the pulse train is N/2 for even mark lengths (4T, 6T, etc) and (N+1)/2 or (N−1)/2 for odd mark lengths (3T, 5T, etc), where N is the length of the mark in channel bits. Using this write strategy a 3T long mark is written with 1 or 2 write pulses, a 4T long mark is written with 2 pulses, a 5T long mark is written with 2 or 3 pulses, a 6T long mark is written with 3 pulses, etc.
3T (or N/3) write strategy: In this write strategy the number of pulses in the pulse train is N/3 for the mark lengths being multiples of 3 (3T, 6T, etc) and (N+1)/3 or (N−1)/3 for the mark lengths not being multiples of 3 (4T, 5T, 7T, etc), where N is the length of the mark in channel bits.

With technological progress new attractive opportunities emerge for data storage. To name a few, semiconductor lasers and laser drivers appear on the market that can generate yet shorter laser pulses. Such shorter laser pulses can be beneficial for precise mark edge positioning leading to less bit errors. Lasers with shorter wavelengths and objective lenses with higher numerical apertures (NA) are developed that allow for a larger storage capacity (for example Blu-ray Disc with blue-violet laser and NA=0.85, and HD-DVD with blue-violet laser and NA=0.7 for DVD data recording which normally uses a red laser and an NA=0.65 objective lens). However, the write strategies currently being applied do not allow using these technological advantages to their full extent.

It is an object of the present invention to provide a recording method and a corresponding recording device, which can make use of technological advantages, examples of which are described above, to their full extent.

This object is achieved according to the present invention by a recording method as claimed in claim 1 which is characterized in that for writing a mark of length NT either a first write strategy using (N+k) write pulses, a second write strategy using trunk(N/2+k) write pulses, or a third write strategy using trunk(N/3+k) write pulses, k being an integer equal to or larger than one, is applied. Here, trunk(x) means a mathematical function to take only the integer value of x in case x has a real value (for example, trunk(2.6) would result in 2).

A corresponding recording device is claimed in claim 7. Preferred embodiments of the invention are defined in the dependent claims.

The present invention is based on the idea to increasing the number of write pulses compared to known write strategies. That is, for a 1T write strategy the number of write pulses of the sequence is increased to N+k, for a 2T write strategy the number of write pulses is increased to trunk(N/2+k), and for a 3T write strategy the number of write pulses is increased to trunk(N/3+k), k being for all cases an integer equal to or larger than one.

By the invention a better thermal management is achieved. Marks with a desired shape can be created; in particular, long marks can be created which are continuous and have the right length. The proposed write strategies thus offer great advantages, especially when employing short-wavelengths lasers and high-NA (numerical aperture) lenses for data recording in the formats that are originally developed for longer wavelength and lower numerical apertures.

It is noted that for particular values of N and k, the number of write pulses used in a particular write strategy according to the present invention for writing a particular mark of length NT may be identical to the number of write pulses proposed by a different, possibly known, write strategy. However, in general a recording device only uses one particular write strategy for writing all marks of different lengths, that is, the particular write strategy and the parameter k is predetermined and fixed, and a recording device does generally not apply different write strategies, and thus different parameters of k, for writing data or marks having different lengths.

According to a preferred embodiment the first write strategy is applied for low speed phase-change recording, the second write strategy is applied for higher speed phase-change recording, and the third write strategy is applied for highest recording speeds. The application of the second and third write strategy is particularly advantageous to prevent re-crystallization during writing of data at high recording speeds. Alternatively, or in addition, the parameter k is selected to be small in case of high-speed recording. Thus, if a higher recording speed is desired, a write strategy and/or a value of the parameter k is selected which results in a low number of write pulses.

For write-once recording, the second and third write strategy may also be advantageous at higher recording speeds. In most of the write-once applications, re-crystallization during recording of data is encountered. But a write-strategy with less write pulses may also be advantageous to control the heat accumulation during writing, and therefore to control the quality of the written pits.

According to another embodiment of the invention the value of parameter k is selected such that for all write strategies the number of write pulses is equal to or larger than the number of periods of the reference clock T, that is, equal to or larger than N. According to this preferred embodiment the number of write pulses is thus larger than the number of write pulses used in all known write strategies.

Furthermore, according to another embodiment, the value of the parameter k is selected to be an integer larger than 1.

According to still another embodiment, for writing marks having a length in the range from NₘᵢₙT to NₘₐₓT, a (N/m+k) write strategy can be used with m being a positive integer larger than 2 and k being larger than (Nₘₐₓm−Nₘₐₓ−m)/m. For example, for a system with Nₘᵢₙ=2 and Nₘₐₓ=8(N/m+k) write strategy can be used with m=3 in combination with k larger than 5.

The invention will now be explained in more detail with reference to the drawings in which

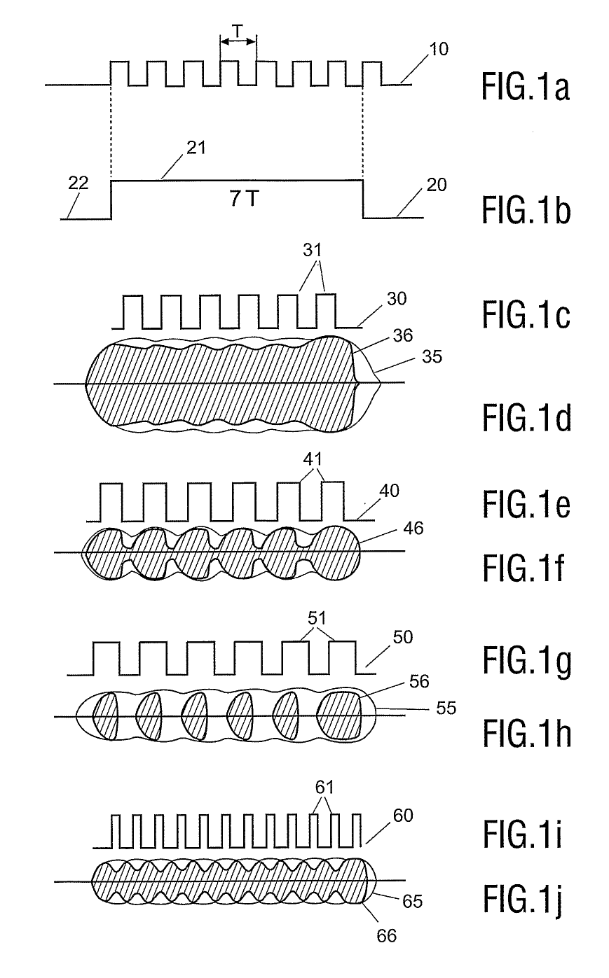

FIG. 1 shows different sequences of write pulses for recording a 7T mark and the resulting mark shapes formed in an information layer of a record carrier,

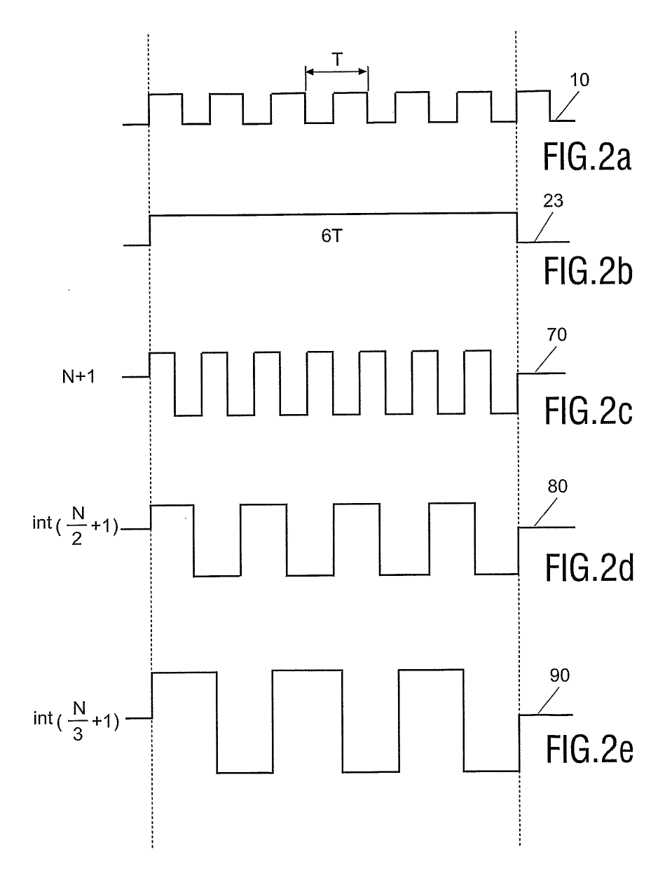

FIG. 2 shows different sequences of write pulses according to the invention for writing a 6T mark,

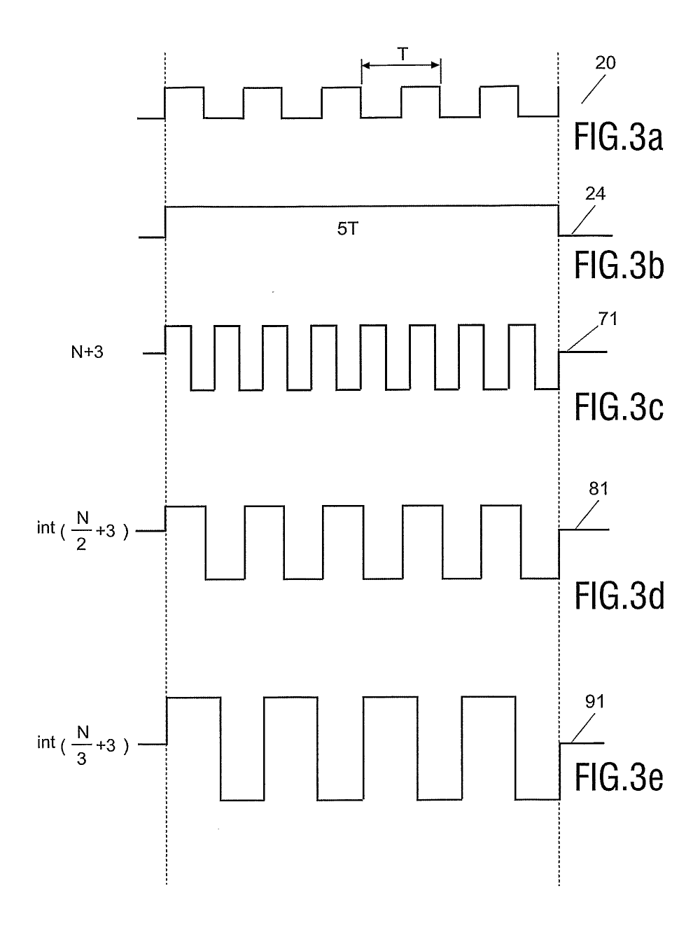

FIG. 3 shows different sequences of write pulses according to the invention for writing a 5T mark, and

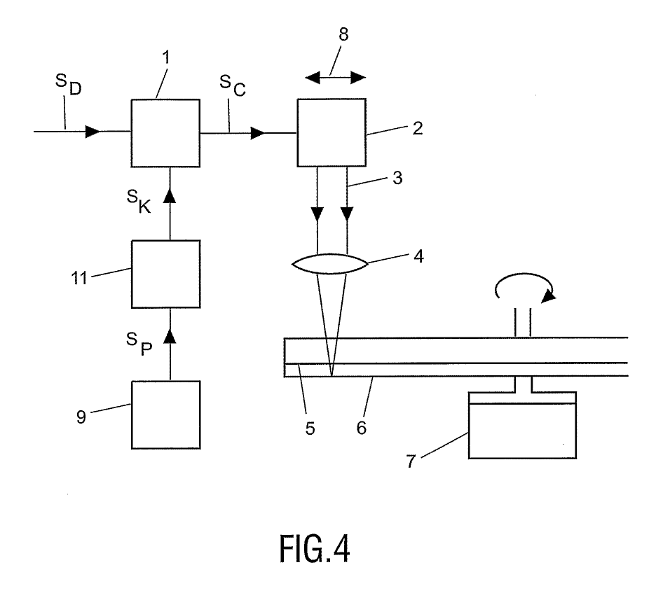

FIG. 4 shows a schematic diagram of a recording device according to the present invention.

FIG. 1a shows a clock signal 10 of a reference clock having a clock period T, also called channel bit period. FIG. 1b shows, as an example, a digital data signal 20 having a “high” period 21 and a “low” period 22. When recording this data signal 20 the “high” period 21 is recorded as a mark having a length corresponding to the duration of the “high” period and the “low” period 22 is recorded as an unwritten area, a space, between the marks and having a length corresponding to the duration of the “low” period. In general, the length of a mark is substantially equal to the number of channel bit periods of the data signal times the writing speed. The length of a mark is thus generally expressed by the number of data clock periods T when the corresponding data signal is “high”. In the example shown in FIG. 1B a mark having a length of 7T shall be recorded for the high period 21.

The data is written in an optical record carrier having an information layer. The marks representing the data are written along a track in the information layer by a radiation beam. The marks are areas of the information layer having optical characteristics which are different from their surroundings, which makes optical reading of marks possible.

FIGS. 1c, 1e, 1g, 1i show different control signals 30, 40, 50, 60 for modulating the power of a radiation beam with which the marks are being written on the information layer. It is assumed that the power level of the radiation beam is proportional to the level of these control signal. The control signals 30, 40, 50 and 60 are applied to write a 7T long mark of the same physical length. FIGS. 1c, 1e, 1g show three sequences of write pulses for writing the 7T mark. The control signal 30 uses an N−1 write strategy, that is, it comprises 6 write pulses 31 for writing the 7T mark.

In FIG. 1d the resulting simulated mark shape is shown which is formed in the information layer (phase-change layer). The solid line 35 indicates the melt-edge, and the shaded area represents the final mark. As can be seen, between the leading and the trailing edges of the mark only a small variation in the mark width is observed. It should be noted that DVD optics (658 nm laser wave length and NA=0.65 objective lens) have been used for obtaining said mark shape 36.

Control signal 40 uses the same N−1 write strategy, that is, again 6 write pulses 41 for writing a 7T mark. However, now using the Blu-ray Disc optics (405 nm laser wave length and NA=0.85 objective lens) a mark 46 consisting of discrete spots and having a melt-edge 45 is formed as shown in FIG. 1f. The mark of such a shape 46 will give rise to significant noise and will affect the bit detection.

Increasing the length of the individual pulses 51 in the control signal 50, as shown in FIG. 1g, does also not lead to the desired result as is shown in FIG. 1h. Due to the longer pulses 51 too much heat is accumulated in the information layer in this case. This leads to severe recrystallization of the marks being written, resulting in a melt-edge 55 and mark shape 56.

A control signal 60 according to the present invention comprising 12 write pulses 61 is shown in FIG. 1i, that is, a sequence of N+5 (7+5=12) write pulses 61 is used to create the 7T mark. When using Blu-ray Disc optics the melt-edge 65 and the mark shape 66 as shown in FIG. 1j are obtained. Compared to the mark shapes 46, 56 obtained with the same optics, the mark shape 66 is much better. In particular much smaller variations in the mark width between the leading and the trailing edges of the mark are obtained. Furthermore, the mark does not appear to consist of discrete spots, which will improve read-out of the mark.

In FIG. 2 several embodiments of control signals for writing a 6T mark using alternative write strategies according to the invention are shown. In FIG. 2a the clock signal 10 is shown again. FIG. 2b shows a digital data signal 23 which shall be recorded as a 6T mark. FIG. 2c shows a control signal 70 of an N+1 write strategy having 7 write pulses. FIG. 2d shows a control signal 80 of a trunk(N/2+1) write strategy having 4 write pulses. FIG. 2e shows a control signal 90 of an trunk(N/3+1) write strategy having 3 write pulses. In these embodiments of the control signals 70, 80, 90 the value of the parameter k is fixed to 1.

FIG. 3 shows further examples of control signals according to the present invention. FIG. 3a again shows the clock signal 10. FIG. 3b shows a digital data signal 24 which shall be recorded as a 5T mark. FIG. 3c shows a control signal 71 of an N+3 write strategy having 8 write pulses. FIG. 3d shows a control signal 81 of an trunk(N/2+3) write strategy having 5 write pulses. FIG. 3e shows a control signal 91 of an trunk(N/3+3) write strategy having 4 write pulses. In the examples shown in FIGS. 3c, 3d, 3e the parameter k is fixed to 3.

FIG. 4 shows an embodiment of a recording device according to the invention. The data signal S_{D} is connected to a control unit 1. A control signal S_{C} provided at the output of the control unit 1 is connected to a radiation source 2, such as for example a semi-conductor laser. The control signal controls the power of a radiation beam 3 generated by this source. The radiation beam is focused onto an information layer 5 of an information carrier 6 in the form of a disc by a lens 4. The information carrier is rotated at a constant angular velocity (CAV) or a constant linear velocity (CLV) around its center by a motor 7. When the radiation source 2 is displaced in a radial direction with respect to the disc, as indicated by arrow 8, the area of the information layer 5 can be irradiated by the beam 3. A position sensor 9 detects the radial position of the radiation beam, for example by determining the radial displacement of the radiation source 2 or by deriving the position from signals read from the information layer via control signal S_{P}. The position is fed into a clock generator 11, which generates a data clock signal S_{K} for modulating the radiation power.

In general, the clock signal is derived from a crystal clock, for example by dividing the crystal clock signal by a number dependent on the radial distance. The control unit 1 combines the data signal S_{D} and the clock signal S_{K} to the control signal S_{C}, for example by means of an AND gate, such that the control signal contains write pulses of substantial equal pulse width and equal power synchronized to the clock signal. The control unit may generate the pulses of equal width by means of a mono-stable multivibrator triggered by the data signal and the clock signal. The multivibrator has preferably an adjustable pulse width to allow for different lengths of the first and last pulse of a sequence for writing a mark. The number of write pulses is calculated according to the predetermined write strategy. Then, for all marks of the same length, the same number of write pulses is applied, that is, the control unit generates the same sequence of write pulses for writing a certain mark. The preferred k, writing speed, and other parameters can be stored the disc such that can be read by the recording device.

1. A method of recording marks representing data in an information layer of a record carrier by irradiating the information layer by means of a pulsed radiation beam, wherein a mark is written by a sequence of write pulses, the number of write pulses in a sequence for writing a mark of length NT, T being the length of a reference clock, being determined by application of a predetermined write strategy,
characterized in that for writing a mark of length NT either a first write strategy using N+k write pulses, a second write strategy using trunk(N/2+k) write pulses, or a third write strategy using trunk(N/3+k) write pulses, k being an integer equal to or larger than one, is applied.

2. A method as claimed in claim 1,
characterized in that for low speed phase-change recording the first write strategy is applied, for higher speed phase-change recording the second write strategy is applied and for highest speed recording the third write strategy is applied.

3. A method as claimed in claim 1,
characterized in that k is selected to be small in case of high speed recording.

4. A method as claimed in claim 1,
characterized in that k is selected such that for all write strategies the number of write pulses is equal to or larger than N.

5. A method as claimed in claim 1,
characterized in that k is selected to be an integer larger than 1.

6. A method as claimed in claim 1,
characterized in that for writing marks having a length in the range from NₘᵢₙT to NₘₐₓT a (N/m+k) write strategy can be used, with m being a positive integer larger than 2 and k being larger than (Nₘₐₓm−Nₘₐₓ−m)/m.

7. A recording device for recording marks representing data in an information layer of a record carrier by irradiating the information layer by means of a radiation beam, wherein a mark is written by a sequence of write pulse, the number of write pulses of the sequence for writing a mark of length NT, T being the length of a reference clock, being determined by application of a predetermined write strategy, the device comprising a radiation source for providing the radiation beam and a control unit operative for controlling the power of the radiation beam and for providing the sequence of write pulse for recording the marks,
characterized in that the control unit is operative for controlling the power of the radiation beam such that for writing a mark of length NT either a first write strategy using N+k write pulses, a second write strategy using trunk(N/2+k) write pulses, or a third write strategy using trunk(N/3+k) write pulses, k being an integer equal to or larger than one, is applied.
